(19) United States
(12) Patent Application Publication
(10) Pub. No.: US 2012/0253989 A1
(43) Pub. Date: Oct. 4, 2012

(54) SYSTEM AND METHOD FOR PAYMENT BY VIRTUAL CREDIT CARD

(75) Inventors: Richard A. Otruba, Algonquin, IL (US); Jeffrey Walter Wiesinger, Carmel, IN (US)

(73) Assignee: CPS Holdings, LLC, Carmel, IN (US)

(21) Appl. No.: 13/436,240

(22) Filed: Mar. 30, 2012

Related U.S. Application Data
(60) Provisional application No. 61/469,116, filed on Mar. 30, 2011.

(51) Int. Cl. G06Q 20/12; G06Q 30/06

(52) U.S. Cl. 705/27.1; 705/26.1

(57) ABSTRACT

The invention relates to vendor payments using a virtual credit card number for security purposes. The invention is used by a company to pay vendors for services or goods using the virtual credit card number, which alleviates the normal security issues associated with making payments through a normal credit card transaction via computer networks. The invention further provides a convenient apparatus and method in securing such vendor payments. The apparatus and method of the present invention operates independently as a stand-alone system that interfaces with a separate accounting system, credit card assignment system, or other components of an invoice payment system, or is integrated with other components of an accounting system.

### CROSS-REFERENCES TO RELATED APPLICATIONS

This application claims priority to U.S. Provisional Patent Application No. 61/469,116 filed on Mar. 30, 2011, entitled Technologies and Techniques for Paying Vendors With a Credit Card Transaction, the entire contents of which is incorporated herein by this reference.

### BACKGROUND OF INVENTION

In today's world of technology, making electronic payments for goods and services has become increasingly convenient in many contexts. Companies and individuals routinely use credit cards to buy goods online and to remit payments to service providers. Electronic funds transfers, electronic checks, and online membership services via the Internet such as Paypal provide additional ways to make payments electronically.

However, there are still numerous challenges in the business-to-business world that have hindered the use of electronic payment mechanisms via the Internet, Wi-Fi and wireless interfaces to pay vendor invoices and to satisfy other types of company payment obligations. Many vendors accept payments by credit card, but standard credit card numbers must be kept secret and are susceptible to fraudulent use if they are disclosed through compromised computer networks. Strict privacy regulations in certain industries, such as the healthcare industry and financial services industry, also hinder the use of credit card payments, since payment processing may require sensitive data to be disclosed to a third party payment processor.

Online payment platforms, such as Paypal, may solve some of these security concerns, but they require payors to entrust their financial information and payment data to the payment platform provider, and they generally require both the payor and payee to sign up for the same payment platform. Use of other electronic payment mechanisms is hindered by rigid remittance formats, security concerns, authentication requirements, and other challenges including computer network connections. Improvements are needed to address some of these challenges and provide for a more convenient and secure method of effecting electronic payments via computer networks.

### SUMMARY OF INVENTION

The present invention facilitates electronic payments to vendors and eliminates or substantially reduces some of the challenges associated with making electronic business-to-business payments via computer networks.

In one aspect, the invention is a payment integration system residing on a computer that can be used to pay vendors for supplied goods and/or services using virtual credit card numbers. The system can be used to obtain payment data, obtain a virtual credit card number, generate and transmit a remittance statement, receive reconciliation data after payment to the vendors, and use the reconciliation data to reconcile payments in payment integration system and/or accounts payable system. In some embodiments, the system is incorporated into a larger system that may include an accounting system, a virtual credit card number assignment system, and/or other components. In other embodiments, the payment integration system operates as a stand-alone system that interfaces with other systems as needed. In some embodiments, the system includes a computer user interface that can used to manually enter payment data, select a data source, and/or initiate, transmit information or control other aspects of the invention.

In another aspect, the invention is an electronic computing method for paying vendors using virtual credit card numbers by obtaining payment data via invoices from the vendors, obtaining a virtual credit card number, generating and transmitting a remittance statement to the vendors, receiving reconciliation data after payment to the vendors, and using the reconciliation data to reconcile payments within the system. In yet other embodiments, the electronic computing method exports and imports data to and from an accounting program. In some embodiments, certain steps of the computing method can be initiated or controlled by an end user through a computer user interface.

In some other embodiment, the invention may utilize virtual credit card numbers that are valid only for a single use and/or are only valid for the exact amount of a payment. In still another embodiment, the invention may utilize remittance statements that are based on a custom template.

These and other aspects, features and advantages of the invention will be understood with reference to the drawings and detailed description herein, and will be realized by means of the various elements and combinations particularly pointed out in the appended claims.

### BRIEF DESCRIPTION OF THE DRAWINGS

FIG. 1 is a process flow diagram outlining a system and method for effecting payments according to a preferred embodiment of the present invention.

FIG. 2 is a simulated screen display for one implementation of the present invention in FIG. 1 that illustrates payment processing functionality for generating payments to vendors.

FIG. 3 is a simulated screen for one implementation of the present invention of FIG. 1 that illustrates payment search functionality that can be used to search for payments that meet specified criteria.

FIG. 4 is a simulated screen for one implementation of the present invention of FIG. 1 that illustrates payment reconciliation functionality.

FIG. 5 is an exemplary remittance statement for use in the present invention of FIG. 1.

FIG. 6 is a diagrammatic view of a computing device that is a component of preferred embodiments of the present invention of FIG. 1.

### DETAILED DESCRIPTION OF INVENTION

While the invention is susceptible to embodiments in many different forms, there are shown in the drawings and will be described herein, in detail, preferred embodiments of the present invention. It should be understood, however, that the present disclosure is to be considered an exemplification of the principles of the invention and is not intended to limit the spirit or scope of the invention and/or claims of the embodiments illustrated.

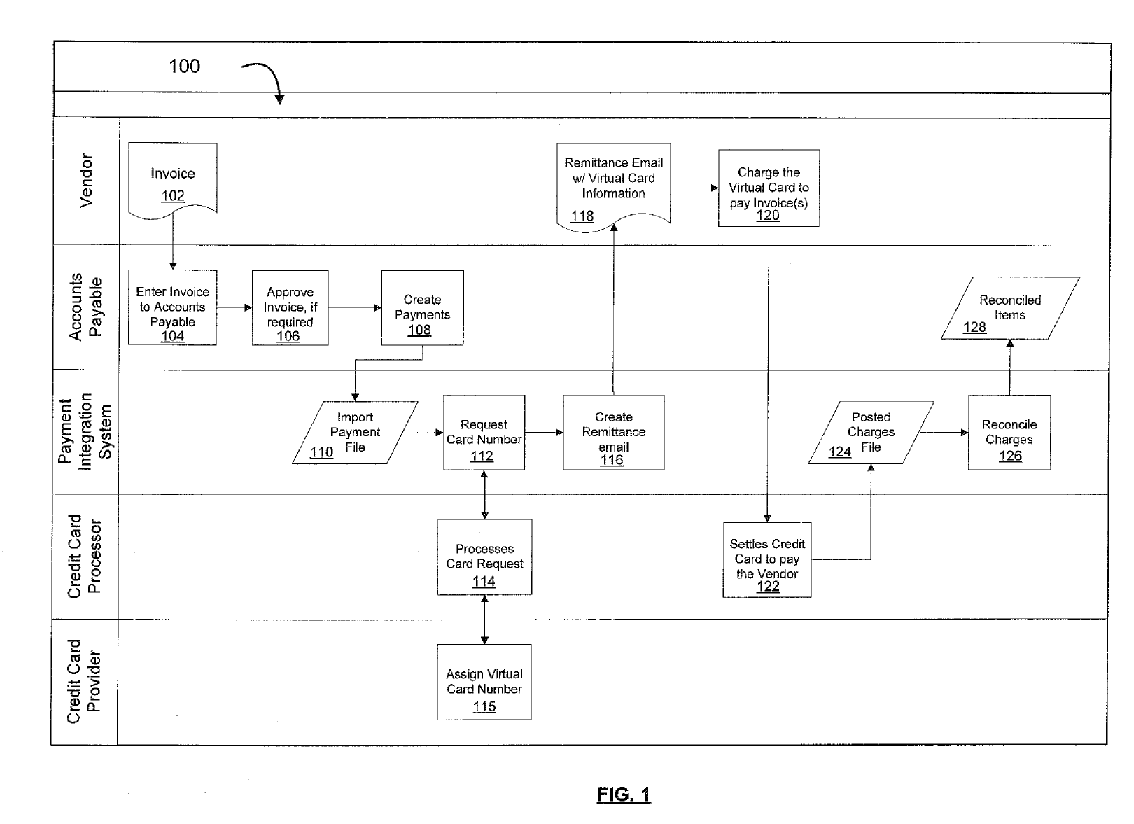

FIG. 1 is a diagrammatic view of an end-to-end payment processing system 100 that utilizes an embodiment of the present invention. In stage 102, a vendor submits an invoice to a company for payment. A representative for the company then enters the invoice into an accounts payable section of the company's accounting system in stage 104. If the accounting system setup requires approval for payment, payment of the invoice is approved in stage 106. In stage 108, payment data is created for the payment to be made to the vendor using the company's accounting system or accounts payable program, and the payment data is saved or exported into an electronic payment file. In one implementation, the payment file includes payment information such as payee, payment amount, payment date, invoice number, invoice date and invoice payment amount.

The payment file is then exported from the accounts payable program and imported into a payment integration system in stage 110. In other embodiments of the invention, payment data may be entered manually or electronically by an end user of the payment integration system or electronically obtained from a data repository such as a database, web service or web site, or obtained from an external accounting system. In still other embodiments, the payment integration system may be combined with or integrated into (e.g., as a plug-in) accounting software such as INTUIT® Quickbooks, MICROSOFT® Office Small Business Accounting, or any other type of program or service that facilitates payments to vendors, in which case the payment data may be obtained from within the program rather than being imported from an external file, data repository or other external source. In some embodiments of the invention, multiple payments to a selected vendor may be consolidated into a single payment based upon predefined or optional matching criteria in stage 110.

Once payment data is obtained, the payment integration system obtains a virtual credit card number for one or more payments in stage 112 from a credit card processor in stage 114 via a process card request or other external source using a web service or other internet protocol-based request mechanism. In other embodiments, a company may obtain a unique transaction identifier with a virtual credit card number from an internal data repository containing valid virtual credit card numbers. In some embodiments, the request for a virtual credit card number will be formatted according to specific card issuer specifications from a Credit Card Provider who then assigns the virtual card number in stage 115 in FIG. 1. In some embodiments, the virtual credit card number will be returned with other appropriate information such as a CVC2 code and an expiration date for security reasons.

In yet another embodiments, the virtual credit card number is only valid for a charge in a specific amount. Additionally or alternatively, in other embodiments, the virtual credit card number can only be changed one time or can only be charged up to a specific dollar limit. These features allow for the charges to be declined if a vendor or any other party tries to charge the card for an unauthorized amount or tries to use the virtual credit card for additional transactions beyond the authorized transaction(s) limits.

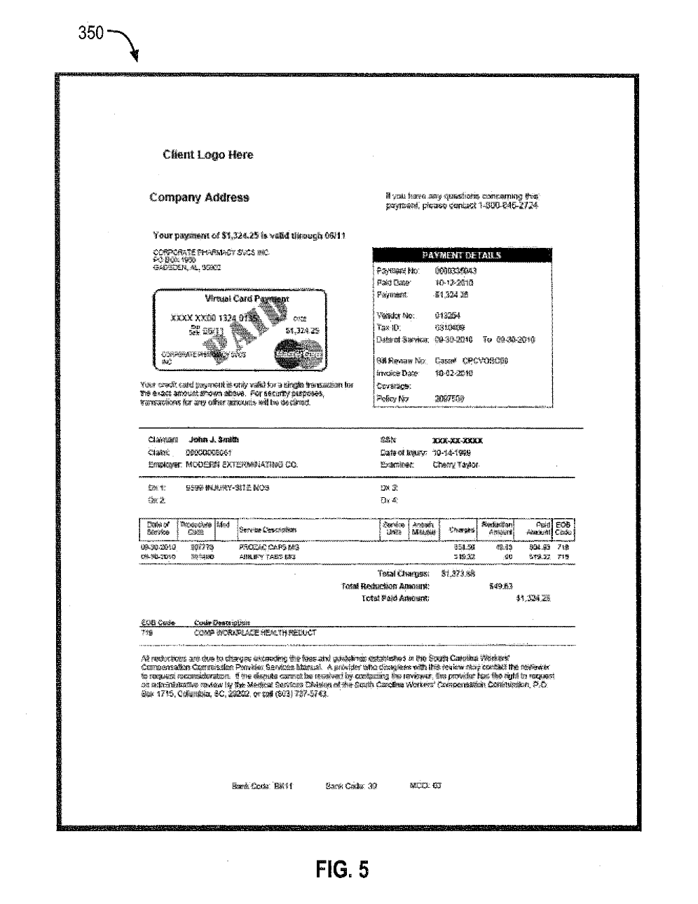

The payment integration system generates or creates a remittance statement for each payment in stage 116. The remittance statement will include information about the invoice to be paid and the virtual credit card number to be used to pay the invoice and may optionally include other information desired by the company or requested or required by the vendor. In some embodiments, remittance statement may be based on a custom template or may be otherwise customized to suit a company's needs and/or a vendor's requirements. The remittance statement is then transmitted to a vendor. The transmission is accomplished by secure or unsecure email, facsimile, internet-based web service, or other data or file transfer mechanism via network communications. In some embodiments, because of increased security provided by having a virtual credit card number that is only authorized for a specific amount or a single use, it may not be important to encrypt or otherwise secure the remittance statement, which is a departure from most normal credit card or PayPal transactions. An example of a remittance statement 350 according to the present invention of FIG. 1 is shown in FIG. 5.

The vendor receives the remittance statement with the virtual credit card number information via email in stage 118. The vendor charges the virtual credit card number to pay the invoice(s) in stage 120. After the virtual credit card number is used and settled to pay the vendor in stage 122 with the Credit Card Processor, reconciliation data is received and the charges posted within the payment integration system at stage 124. In various embodiments, reconciliation data of the posted charges may be received via file import, from a data repository, from an accounting system, via manual user entry of the data, or manually-entered data entered by user, and/or via connection to an external data source via internet protocols.

The reconciliation data is used to match the issued or charged payments with those that were successfully processed in stage 126. The reconciled items from the paid vendor charges can be exported from the payment integration system and imported back into the accounts payable or accounting system in stage 128, which will allow the accounting system to identify the invoices as paid and then obtain other applicable transaction details. In the alternative embodiment where the payment integration system is integrated within an accounting system, the stage of exporting reconciled items may not be necessary. Additionally or alternatively, in some embodiments, reconciled data may be exported to a flat file or data repository. In some embodiments, the system may support the automatic and/or manual generation of reports of reconciled items.

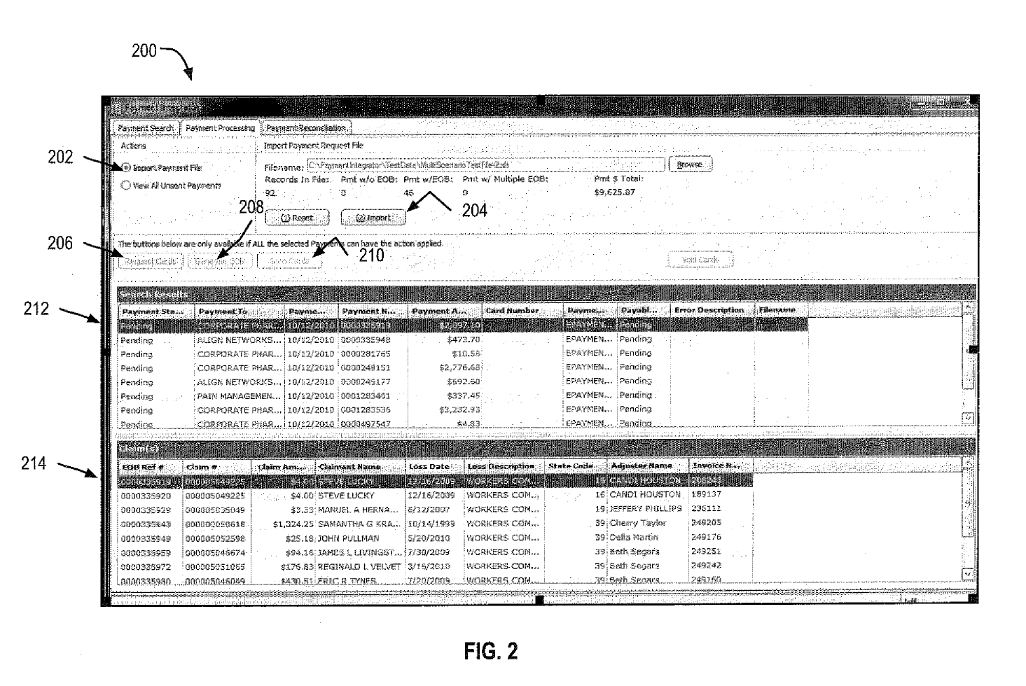

FIGS. 2 through 4 show simulated screen displays that illustrate a user interface for an exemplary payment integration system.

FIG. 2 shows a simulated screen 200 that illustrates payment processing functionality of an exemplary payment integration system. An import payment file option 202 can be selected, and a selected payment file can be imported by clicking import button 204. Upon selecting a list of payments that need to have a virtual credit card numbers assigned, the request cards button 206 can be selected to submit a request for a virtual credit card number. A generate EOB button 208 can be used to generate a remittance statement for the selected payment(s). The send cards button 210 can be used to send the selected remittance statement(s) to the appropriate vendor(s) for payment by email, fax, or other method selected by the user and supported by the payment integration system and the vendor. A search results area 212 displays the payments that have been imported and/or that meet a specified criteria. A claims area 214 displays claim information that is associated with a particular payment that is selected in the search results area 212.

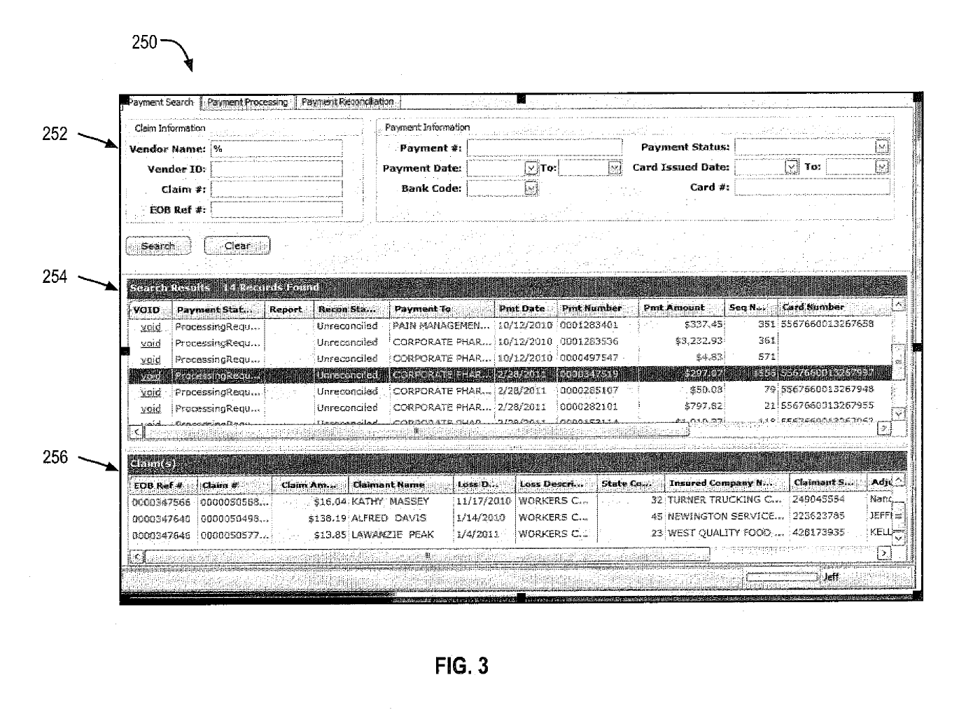

FIG. 3 is a simulated screen 250 that illustrates a payment search feature that can be utilized to search for completed payments that meet a specified criteria. The search criteria can be specified in the search section 252, and the search results are displayed in the search results area 254. A claims area 256 displays claim information that is associated with a particular payment that is selected in the search results area 254.

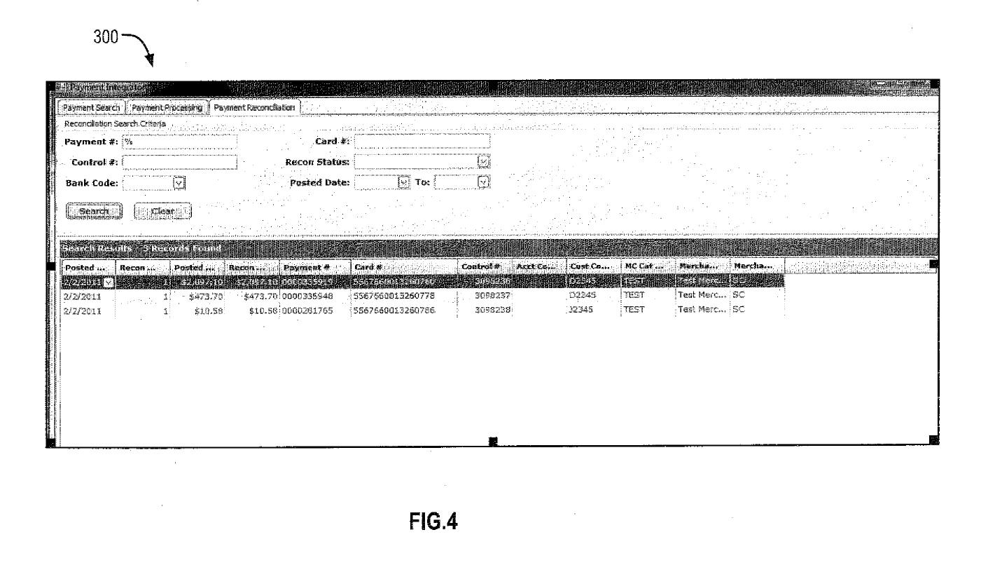

FIG. 4 is a simulated screen 300 that illustrates a user interface for the reconciliation functionality of an exemplary payment integration system. Payments can be fully or partially reconciled. In one implementation, reconciliation exceptions are managed in the payment integration system, through data export and through reports.

FIG. 5 is an exemplary remittance statement 350 that provides the payment details, virtual credit card number, and information about the invoice that will be paid.

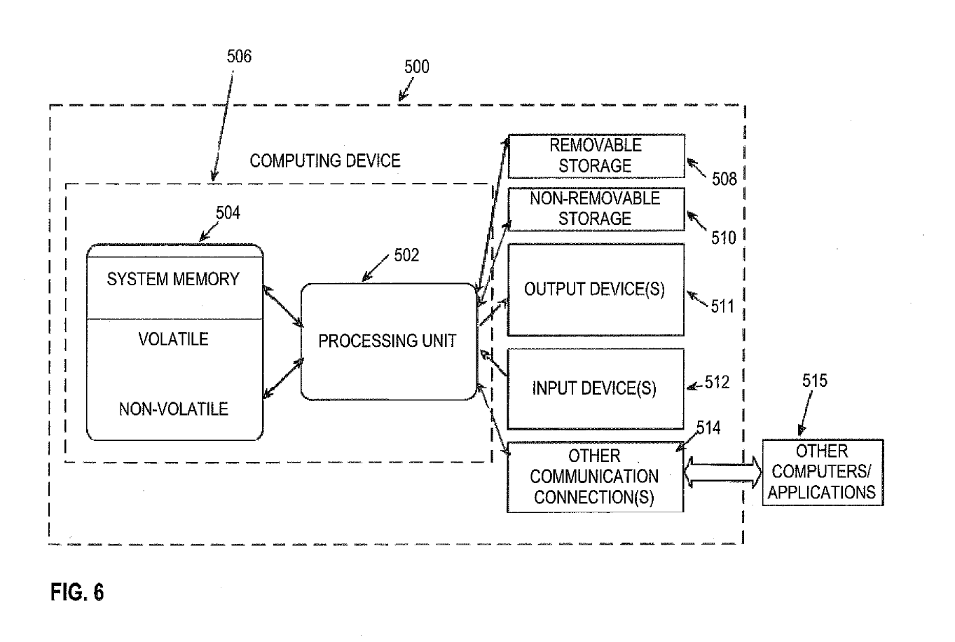

FIG. 6 is an exemplary computing device 500 to use in implementing one or more parts of the exemplary payment integration systems described above. Computer system 500 includes computing device 506 which, in its most basic configuration, includes at least one processing unit 502 and an electronically connected system memory 504 for storing instructions of a predetermined computer-implemented payment system to execute the payment request from the vendor(s). Depending on the exact configuration and type of computing device, system memory 504 may be volatile (such as RAM), non-volatile (such as ROM, flash memory, etc.) or some combination of the two.

Additionally, computing device 500 may also have additional features/functionality. For example, computing device 500 may include additional removable computer-readable storage 508 or non-removable computer-readable storage 510, which may take the form of magnetic or optical disks or solid state harddrive or tape or other media. Computer-readable storage media includes volatile and nonvolatile, removable and non-removable media implemented in any method or technology for storage of information that may be retrieved by a computer such as computer readable instructions, data structures, program modules or other data. System memory 504, removable storage 508 and non-removable storage 510 are all examples of computer-readable storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can accessed by computing device 500.

The computing device 500 includes one or more other communication connections 514 such as various computer network connections that allow the computing device 500 to communicate through a network interface device with other computers/applications 515 tied through the network interface to a host of various communications methods such as an Ethernet, Wi-Fi, Wireless, or Internet connections. The computing device 500 further includes one or more input device(s) 512 such as a keyboard, mouse, pen, voice input device, touch input device, or a smart phone, and further includes one or more output device(s) 511 such as a display monitor, speakers, or printer. Various aspects of the payment integration system, including simulated screens 200, 250 and 300, can be displayed to users on output device(s) 511 including the monitor that receives input signals from input device(s) 512 to display payment data information required to make the payment of the vendor invoices submitted to the company for payment that received the vendor provided services or goods.

A computer-implemented payment integration system 500 for a payment of a vendor for supplied goods or services using a virtual credit card number 115, comprises a computer processor 502; a computer-readable storage medium 504 connected to the computer processor 502; a payment integration system program stored in the computer-readable storage medium 504, 508 or 510, configured for execution on the processor 502 in order to cause the payment integration system as shown in FIG. 1 to obtain payment data 108 from an invoice 102 and in order to obtain the virtual credit card number 115 for the payment and in order to generate a remittance statement containing the payment data for the payment and in order to transmit the remittance statement 116 with the virtual credit card number 115 to the vendor 118 and in order to obtain posted charges 124 related to vendor submittal 122 of the remittance statement 118, 120 with virtual credit number for the payment and in order to receive reconcilable data or charges 126 from the posted charges 124 related to the payment 122 having been made to the vendor and to use the reconcilable data or charges 126 to reconcile items 128 covered by the payment.

Therefore, the present invention relates to a computerized vendor payment system using a virtual credit card number for security purposes. A company is able to pay vendors for services or goods using the virtual credit card number, which alleviates the normal security issues associated with making payments through a normal credit card transaction via computer networks or the Internet. The invention further provides a convenient apparatus and method for securing such vendor payments. The apparatus and method of the present invention operate independently as a stand-alone system that interfaces with a separate accounting system, credit card assignment system, or other components of an invoice payment system, or is integrated with other components of an accounting system.

The embodiments of the invention described herein are exemplary, and numerous modifications, variations and rearrangements can be readily envisioned to achieve substantially equivalent results, all of which are intended to be embraced within the spirit and scope of the invention as defined in the appended claims. For example, but without limitation, a person of ordinary skill in the computer software art will recognize that the examples discussed herein could be organized differently on one or more computers to include fewer or additional options or features than as portrayed in the examples.

We claim:

1. A computer-implemented payment integration system for a payment of a vendor for supplied goods or services using a virtual credit card number, comprising:
a computer processor;
a computer-readable storage medium connected to the computer processor;
a payment integration system program stored in the computer-readable storage medium, configured for execution on the processor in order to cause the payment integration system to obtain payment data from an invoice, to obtain the virtual credit card number for the payment, to generate a remittance statement containing the payment data for the payment, to transmit the remittance statement with the virtual credit card number to the vendor, to obtain posted charges related to vendor submittal of the remittance statement with virtual credit number for the payment, to receive reconcilable data or charges from the posted charges related to the payment having been made to the vendor, and to use the reconcilable data or charges to reconcile items covered by the payment.

2. The system of claim 1 wherein the virtual credit card number is valid only for a single use or transaction.

3. The system of claim 1 wherein the virtual credit card number is valid only for the exact amount of the payment.

4. The system of claim 1 wherein the virtual credit card number is valid only up to a specific limit.

5. The system of claim 1 wherein the payment data is obtained by importing the payment data from a payment file.

6. The system of claim 1, further comprising a network interface to a computer network connection, wherein the payment data is obtained by importing the payment data from a data repository over the computer network connection.

7. The system of claim 1, wherein the virtual credit card number is obtained from an internal data repository stored on the computer-readable storage medium.

8. The system of claim 1, further comprising a network interface to a computer network connection, wherein the virtual credit card number is obtained from an external source by transmitting a request for the virtual credit card number to an external source over the computer network connection and receiving the virtual credit card number from the external source over the computer network connection.

9. The system of claim 1, further comprising:
an accounting system program stored in the computer-readable storage medium; and
wherein the payment data is obtained by importing the payment data from the accounting system program; and
wherein the reconcilable data is exported to the accounting system program.

10. The system of claim 1, further comprising:
an accounting system program stored in the computer-readable storage medium; and
wherein the payment integration system program is integrated into the accounting system program;
wherein the payment data is obtained from the accounting system program; and
wherein the reconcilable data is returned to the accounting system program.

11. The system of claim 1, further comprising:
a user interface device connected to the computer processor comprising at least one display being configured to display in conjunction with execution of the payment program; and
an input device connected to the computer processor configured to allow a user to manually enter payment data, to initiate the importation of the payment file, to initiate the request for the virtual credit card number, to initiate the generation of the remittance statement, to initiate the transmittal of the remittance statement, to review and search payment data via the user interface display, and to reconcile payments with the submitted invoice;
wherein the payment data is obtained by the user inputting payment data from the invoice through the input device.

12. The system of claim 1, further comprising:
a user interface device connected to the computer processor comprising at least one display being configured to display a payment information in conjunction with execution of the payment program; and
an input device connected to the computer processor configured to allow a user to select a source of the payment data, to initiate the importation of the payment file, to initiate the request for the virtual credit card number, to initiate the generation of the remittance statement, to initiate the transmittal of the remittance statement, to review and search payment data displayed on the user interface display, and to reconcile payments to the submitted invoice;
wherein the payment data is obtained from the source selected by the user.

13. A computer-implemented method for a payment to a vendor using a virtual credit card number, comprising the steps of:
obtaining payment data related to a vendor invoice for the payment in a payment integration system program stored in a computer-readable storage medium on a computing device comprising the computer-readable storage medium and a computer processor connected to the computer-readable storage medium;
obtaining a virtual credit card number for the payment stored in the computing device;
generating a remittance statement with the virtual card number for the payment;
transmitting the remittance statement over a communications network connected to the computing device with the virtual card number to the vendor;
posting the charges of the payment being made to the vendor in the payment program;
creating reconcilable data or charges from the posted charges; and
using the reconcilable data or charges to reconcile items related to the payment in the program or in an accounting program.

14. The method of claim 13 wherein the virtual credit card number is valid only for a single use.

15. The method of claim 13 wherein the virtual credit card number is valid only for the exact amount of the payment.

16. The method of claim 13 wherein the virtual credit card number is valid only up to a specific limit.

17. The method of claim 13 wherein the payment data is obtained by importing the payment data from a payment file related to the vendor invoice.

18. The method of claim 13, wherein the payment integration system program is stored in a computer-readable storage medium on a computing device further comprising other communication connections having a network interface device to other computer network connections having other computer applications, and wherein the step of obtaining payment data comprises importing the payment data from a data repository from the other computer applications over the network interface device to the other communication connections of the computing device.

19. The method of claim 13, wherein the virtual credit card number is obtained from an internal data repository stored on the computer-readable storage medium.

20. The method of claim 13, wherein the payment integration system program is stored in a computer-readable storage medium on a computing device further comprising a network interface to a computer network connection, and wherein the step of obtaining a virtual credit card number comprises transmitting a request for the virtual credit card number to an external source over the computer network connection and receiving the virtual credit card number from the external source over the computer network connection via the network interface.

21. The method of claim 13, further comprising the step of:
exporting the reconcilable data to an accounting system program;
wherein the payment integration system program is stored in a computer-readable storage medium on a computing device further comprising the accounting system program stored in the computer-readable storage medium; and
wherein the step of obtaining payment data comprises importing the payment data from the accounting system program.

22. The method of claim 13, further comprising the step of:
returning the reconciliation data to an integrated accounting system program;
wherein the step of obtaining payment data comprises obtaining the payment data from the integrated accounting system program.

23. The method of claim 13, wherein the payment system program is stored in a computer-readable storage medium on a computing device further comprising a user interface comprising at least one display being configured to display in conjunction with execution of the payment program and an input device configured to allow a user to manually enter payment data, initiating the importation of the payment file, initiate the request for the virtual credit card number, initiating the generation of the remittance statement, initiating the transmittal of the remittance statement, initiating review and search payment data, and initiating reconcilable payments, and wherein the step of obtaining payment data comprises obtaining the payment data from the user input device.

24. The method of claim 13, wherein the payment system program is stored in a computer-readable storage medium on a computing device further comprising a user interface comprising at least one display being configured to display in conjunction with execution of the payment program and an input device configured to allow a user to select a source of the payment data, initiating the importation of the payment file, initiate the request for the virtual credit card number, initiating the generation of the remittance statement, initiate the transmittal of the remittance statement, initiating review and search payment data, and initiating reconcilable payments, and wherein the step of obtaining payment data comprises obtaining the payment data from the source selected by the user.

25. A computer-implemented payment integration system for a payment to a vendor using a virtual credit card number, comprising:
a computer processor;
a computer-readable storage medium connected to the computer processor;
a payment integration system program stored in the computer-readable storage medium, configured for execution on the processor in order to cause the payment integration system to obtain payment data for multiple payment amounts related to an invoice from the vendor, to consolidate the multiple payment amounts into a single payment, to obtain a virtual credit card number for the single payment, to generate a remittance statement for the payment with the virtual card number, transmit the remittance statement to the vendor with the virtual card number, receive posted reconcilable data or charges of the payment having been made to the vendor, and to use the reconcilable data to reconcile the payment with the payment amounts on the vendor invoice.

26. A computer-implemented method for payment of a vendor using a virtual credit card number, comprising the steps of:
obtaining payment data for multiple payment amounts from a vendor invoice in a payment integration system program stored in a computer-readable storage medium on a computing device comprising the computer-readable storage medium and a computer processor connected to the computer-readable storage medium;
consolidating the multiple payment amounts into a single payment;
obtaining a virtual credit card number for the payment;
generating a remittance statement for the payment with the virtual credit card number;
transmitting the remittance statement with virtual credit card number to the vendor;
receiving reconcilable data for the payment having been made to the vendor; and
using the reconcilable data to reconcile the payment with the payment amounts on the invoice.
